(19) United States
(12) Patent Application Publication
(10) Pub. No.: US 2005/0256918 A1
(43) Pub. Date: Nov. 17, 2005

(54) Rotational sliding aperture fourier transform

(76) Inventor: Walter E. Pelton, Fremont, CA (US)

Correspondence Address: EVAN LAW GROUP LLC, 566 WEST ADAMS, SUITE 350, CHICAGO, IL, 60661, US

(21) Appl. No.: 11/124,912

(22) Filed: May 9, 2005

Related U.S. Application Data
(60) Provisional application No. 60/568,976, filed on May 7, 2004.

(51) Int. Cl. G06F 15/00

(52) U.S. Cl. 708/405

(57) ABSTRACT

A method of determining a coefficient of a function representative of a signal, comprises adding a first complex value representative of a first sample of the signal to a coefficient register, and rotating the coefficient.

### CROSS REFERENCE TO RELATED APPLICATION

This application claims the benefit of U.S. Provisional Application No. 60/568,976 filed 7 May 2004.

### BACKGROUND

Signal processing is an important function in electronic systems. The Discrete Fourier Transform (DFT) is the digital approximation of choice to the Fourier series and is the principal method used to convert time domain signals to the frequency domain. It is used to process digitized analog information and for image compression. The DFT replaces the continuous input values of the Fourier Series with a finite set of N evenly spaced samples taken over a finite period of N sample-times and returns a finite series of N coefficients. The DFT is an important tool for electronics, engineering and the communication field.

Whereas the Fourier Transform is a continuous time-integration over each frequency from minus infinity to plus infinity, the Discrete Fourier Transform is a set of N points and is defined to be square. The value of N may be any positive integer. The DFT must form the product of each sample with sine and cosine of each angular argument and sum over all of the samples. This implies N² Multiply Accumulate Cycles (MAC) cycles and is formally referred to as the order of N squared O(N²). The DFT of a signal is typically computation and time intensive [7][8]. The equations for the Fourier Transform and the Inverse Fourier Transform (Euler's equations) are shown below [6].

$$F ( \frac{n}{NT} ) = {\sum }_{k = 0}^{N - 1} f ( kT ) {ⅇ}^{- 2 π ⅈ kn / N}$$

$$f ( kT ) = \frac{1}{N} {\sum }_{n = 0}^{N - 1} F ( \frac{n}{NT} ) {ⅇ}^{2 π ⅈ kn / N}$$

Even though discrete Fourier transforms help in the conversion of analog to digital and vice versa, it requires substantial computational power. Therefore, there have been many attempts to reduce the computation of the algorithm [16][17]. A thoughtful extension of previous methods and mathematical options was carried out by Cooley and Tukey, and resulted in a formal procedure [4]. The outcome was called the Fast Fourier Transform (FFT).

The FFT is the form of the Fourier Transform that is used almost universally for computing the DFT [1][2][3]. The significant advantage of the FFT over a direct implementation of the DFT is in terms of the number of required MAC cycles. The FFT achieves its speed by a mathematical artifact called the Butterfly, which converts the N-point signal to N-single-point signals using decomposition into even and odd groups. It requires log₂ (N) stages with N multiplies per stage. However, FFT is limited to numbers of samples being a power of two. Any other number will be padded with zeros to the next higher power of two and processed. This computation of the FFT has the overhead of reduced efficiency [19].

The Butterfly processes the sample interdependently and requires all the samples in order to begin, and therefore does not begin determination of the coefficients until after all of the samples have been received. It does reduce the number of multiplies from N² to N log N. It is a batch process, and therefore must be run repetitively to process a sample stream. A property of the Butterfly pipeline is that it requires a period T for the acquisition of the N samples as well as a period not greater than T, to process the samples. The batch processing after the sample collection is a hidden time called latency. It requires memory to store samples and a random addressing scheme.

Many methods have been proposed as attempts to develop a digital sliding aperture Fourier Transform that allows partial updates of an existing transform without having to go through a whole transform computation as each new sample arrives. This currently requires a prohibitive amount of computational power for practical applications, and therefore it is usually done by analog methods [11]. Many methods of solving this have been developed and introduced with steadily increasing efficiency [12]. Direct computation of the sliding aperture Fourier Transform has become one of the most sought-after methods to accomplish the task.

There are three methods that have been proposed in this area. The first method is a discrete fractional Fourier Transform of Santhanam and McClellan, which takes O(N log N) [5]. The second one is a digital computation method of Ozaktas, which takes O(N²) [5]. The third method is a novel discrete fractional Fourier Transform, which was presented at the 2001 CIE International Conference On Radar Processing in Beijing, China by Tao Ran et al. of the Beijing Institute of Technology which offers the easiest method to understand and implement that has otherwise been published, which is accurate and surpassed the previous two methods with its efficiency and accuracy [5]. However, even though this third method claims to be the simplest and easiest algorithm to solve the fractional Fourier transform with a simple computation and provide a correct solution, it is still a complicated formula that is difficult to understand.

Sample Integrated Fourier Transform (SIFT) is an alternative method to the Fast Fourier Transform (FFT) that increases speed as it reduces power and size while providing a numerically identical result. As its name implies, SIFT integrates all coefficients in parallel with the arrival of each sample to compute the Fourier transform. SIFT recognizes the DFT property of the independence of samples: each sample adds a quantity to each coefficient based on its value and location independent of all other samples. Therefore, SIFT uses this basis to determine the coefficients of a function representative of an input signal as each sample of the signal is received. A process that uses information on receipt is called transactional, as opposed to a batch process that accumulates all samples before beginning processing. The delay of the batch process is called latency. When the final sample is received, SIFT needs only to update each coefficient with the contribution of the last sample prior to outputting the coefficients.

In the case of the Discrete Fourier Transform (DFT), a coefficient is the sum of the N discrete samples multiplied by the values of the trigonometric functions at the sample points using Euler's equation. The table below lists the DFT Equation for 16 samples.

$$x := 1 , 2 … 16$$

$$z0 ( x ) := \frac{1}{16} z1 ( x ) := cos ( \frac{1 π \cdot x}{8} ) z2 ( x ) := cos ( \frac{2 π \cdot x}{8} )$$

$$z3 ( x ) := cos ( \frac{3 π \cdot x}{8} ) z4 ( x ) := cos ( \frac{4 π \cdot x}{8} ) z5 ( x ) := cos ( \frac{5 π \cdot x}{8} )$$

$$z6 ( x ) := cos ( \frac{6 π \cdot x}{8} ) z7 ( x ) := cos ( \frac{7 π \cdot x}{8} ) z8 ( x ) := cos ( \frac{8 π \cdot x}{16} )$$

$$y1 ( x ) := sin ( \frac{1 π \cdot x}{8} ) y2 ( x ) := sin ( \frac{2 π \cdot x}{8} ) y3 ( x ) := sin ( \frac{3 π \cdot x}{8} )$$

$$y4 ( x ) := sin ( \frac{4 π \cdot x}{8} ) y5 ( x ) := sin ( \frac{5 π \cdot x}{8} ) y6 ( x ) := sin ( \frac{6 π \cdot x}{8} )$$

$$y7 ( x ) := sin ( \frac{7 π \cdot x}{8} )$$

The first sample is multiplied by cos(2nπ/N) and added to Aₙ as the real component. It is then multiplied by sin(2nπ/N) and added to Bₙ as the imaginary component. This is repeated for A₀ through A_{N/2} and B₀ through B_{N/2}. The effect is to rotate the sequence of samples to the angles: (1, 2, . . . N/2)(2π/N) radians.

Each rotated sample provides vector components that are added to the complex coefficient (Aₙ+iBₙ). This process is repeated until the N^{th} sample. Each sample is rotated forward in uniform steps that increase with higher frequency coefficients. The magnitudes of the coefficients are always correct, but they are not in the normal position. As N samples are added to the coefficient registers, the last sample produces an aligned set of vectors and completed coefficients. The samples are processed in natural order but the pattern of arguments is somewhat complicated. SIFT uses N² multiplies but can do them up to N wide (i.e. in parallel, since each sample is independent). It also has unidirectional and direct buses and is pipe friendly.

The SIFT architecture is an Autonomous Functional Unit (AFU). This term is defined as a stand-alone gated module that can operate from a reset, clock and data-in bus and provides coefficients without the need for other connections. It does not require instructions. Its internal state may be predicted exactly, and the correct output terms may be copied from the bus with certainty. The structure permits that a subset of the coefficients may be generated with a significant savings of hardware. It also permits the bus to share only the chosen outputs to thereby decrease the actual bandwidth. These and other extra features are easily provided but are not mandatory.

The SIFT method may be used to much more efficiently provide a Sliding Aperture Fourier Transform (SAFT). Consider a set of N registers holding N coefficients. A computing system adds a contribution to each of the N coefficients upon the arrival of each sample. The trigonometric values are computed for t=2π(f)(1)/N for sample 1, t=2π(f)(2)/N for sample 2 and onward to t=2π(f)(N)/N for sample N. The value of (f) ranges from one to N/2 to accommodate the angular rate of each of the coefficients. When N consecutive samples have been processed, the coefficients are completed and transmitted during that sample time.

The diagram in FIG. 1 illustrates the computation of a coefficient where N=8, indicating the calculation of each partial coefficient from the previous partial coefficient plus a contribution determined by the latest sample (as vectors). Each sample brings a contribution as a vector, of magnitude given by the sample, and direction/angle advancing with (2π)/N during each sample time. Thus, the first sample, S1, is plotted at 45°, (360°/8) starting at the origin. In general form its projection along the X0 axis is S1*cos(j*45°), which is Aⱼ, and its projection along X90 is S1*sin(j*45°) which is Bj. FIG. 1 shows the case of the fundamental or j=1 coefficient, but the same reasoning applies to any value of “j”.

When the next sample arrives, it replaces the first sample. The oldest contribution to each coefficient is subtracted and the appropriate contribution from the new sample is added. Again referring to FIG. 1, when S9 arrives, it will be plotted parallel to S1. Coefficient C9 is based on the latest 8 samples, i.e. S2 to S9. Thus C9=C8+S9−S1. We subtract S1 from S9 and plot the magnitude parallel to S1 and with the direction determined by its sign, starting from the end of C8. Its terminus then is the coefficient C9, which yields the coefficients A1 and B1 of S2 through S9. The only problem with C9 is that it is rotated by 45°. We want its projections on 45° and 135° to obtain the classical coefficients since the current axis of reference after sample S9 is X45. In this way, the SAFT using SIFT can be determined upon the arrival of each sample using N MAC cycles to up date each coefficient, and N rotations to obtain the classical (i.e. normalized) coefficients.

### BRIEF SUMMARY

In a first aspect, the present invention is a method of determining a coefficient of a function representative of a signal, comprising: (a) adding a first complex value representative of a first sample of the signal to a coefficient register; and (b) rotating the coefficient.

In a second aspect, the present invention is a method of determining a plurality of coefficients of a function representative of a signal, comprising: determining each of the coefficients by the above method. The plurality is n.

In a third aspect, the present invention is a method of determining a coefficient of a function representative of a first portion of a signal, comprising: (a) adding a 2n^{th} complex value to a coefficient register; and (b) rotating the coefficient. The register contains a coefficient of the function representative of a second portion of the signal, n is at least 2, the 2n^{th} complex value is the difference between an n^{th} sample of the signal and a 2n^{th} sample of the signal, the second portion is of the same length as the first portion, and each sample of the signal is obtained at identically spaced time intervals corresponding to the length of the first portion divided by n.

In a fourth aspect, the present invention is an apparatus for determining a coefficient of a function representative of a signal, comprising: an interface adapted to receive the signal and to sample the signal to form a plurality of samples; a memory adapted to store a plurality of coefficients; and a processor coupled to the memory and to the interface. The processor is adapted to add a next plurality of samples to the plurality of coefficients and to rotate each coefficient of the plurality of coefficients by a corresponding angular factor, and to provide the rotated plurality of coefficients as a plurality of coefficients.

In a fifth aspect, the present invention is a tangible medium storing computer readable software for determining a coefficient of a function representative of a signal, the tangible medium storing computer readable software comprising: (a) a first program for adding a first complex value representative of a first sample of the signal to a coefficient register, and (b) a second program for rotating the coefficient.

### BRIEF DESCRIPTION OF THE DRAWINGS

FIG. 1 is a stoica diagram of general coefficient C.

FIG. 2 is an illustration of RSIFT rotation calculation in an 8 sample set.

FIG. 3 is a flowchart illustrating RSAFT.

FIG. 4 is a diagram of a RSIFT atom network.

FIG. 5 is a diagram of a circuit for carrying out RSIFT for complex samples.

FIG. 6 is a diagram of a circuit for carrying out RSAFT for complex samples.

FIG. 7 is an illustration of RSAFT rotation calculation in an 8 sample set.

FIG. 8 is a flowchart illustrating RSIFT.

FIG. 9 is a flowchart illustrating RSAFT.

FIG. 10 is a diagram of an exemplary apparatus.

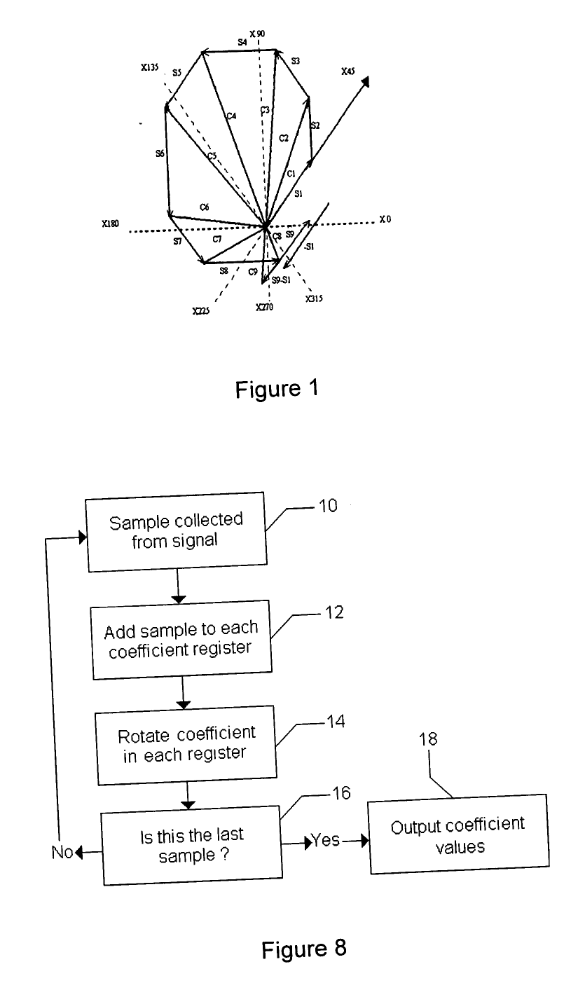

### DETAILED DESCRIPTION

A close examination of the SIFT process reveals that each sample is actually rotated forward in uniform steps that increase with higher coefficients.

The coefficient magnitudes are correct, but they are not in usable angular positions. After the samples are rotated, they are added to the coefficient registers until the last sample produces a fully aligned set of vectors and completed coefficients. The first sample is multiplied by the cosine of zero radians, which is “one”, and then added to A₁. It is then multiplied by the sine of zero radians, which is “zero”, and then added to B₁. This is repeated for A₂ through A_{N/2} and B₂ through B_{N/2} (this is zero for all Bₙ). On arrival of the second sample, it is multiplied by the cosine of (2π)/N radians and then added to A₁. The second sample is then multiplied by the sine of (2π)/N radians and then added to B₁. This is repeated for A₂ through A_{N/2} and B₂ through B_{N/2} using 2, 3, . . . 2N times the first argument. The effect is to rotate the sample to each of the angles: (1, 2, . . . N/2)×(2π/N) radians. Each rotation of the sample is then vector added to one complex coefficient (Aₙ+iBₙ). Similarly, on the arrival of the third sample, it is multiplied by the cosine of n(4π)/N radians and then added to Aₙ and then by the sine of (4π)/N radians and then added to Bₙ in a like manner. The magnitude is not altered, but the sample is repositioned to match the reference angle of each of the coefficients at the then current sample point. This process is repeated until the N^{th} sample.

The present invention is based on the discovery that this process can be done another way. The real and imaginary parts of the samples are added to the corresponding parts of each coefficient, and then the coefficients are rotated backward by the corresponding angle. Therefore, after each sample is added to the coefficients and each coefficient is rotated, the angle of each coefficient will be normal; the result is the same as the classical transform. This is referred to as Rotational Sample Integrated Fourier Transform (RSIFT).

Although the result is the same as SIFT, there is a difference in the computations. Since the coefficients are always rotated back to their normal positions, the samples simply add. This means that the complex (or real) sample is simply added to each current coefficient each time. It also means that each successive coefficient is recessed by 1/N radians more than the preceding one, and therefore trigonometric functions necessary for the rotation of the coefficients are only required in natural ascending order. RSIFT uses Add Rotate Cycles (ARC) instead of the MAC used by SIFT.

A digital sliding aperture Fourier Transform may be implemented as a simple and natural extension of RSIFT. All coefficients are updated upon the arrival of the next sample by subtracting the oldest sample from this next sample, adding the difference to each coefficient and then rotating each coefficient. This is referred to as Rotational Sliding Aperture Fourier Transform (RSAFT).

RSAFT results in a sequence of complete transforms that are updated at each sample time with the same amount of additional computation as is need per sample in RSIFT, and therefore there is no latency. Only N ARC cycles are required per transform update. Furthermore, it is not always necessary in applications to update all coefficients, and with both RSIFT and RSAFT this will require less computation than updating all the coefficients: if only three coefficients are required then only three ARC cycles are required per update for any N. Furthermore, these can be performed in parallel. RSAFT is computationally efficient because it uses the samples in their natural order. It only adds a requirement to store the last N samples and subtract the N-ago sample from the new. RSAFT is a transactional and atomic process, which offers parallel scalability.

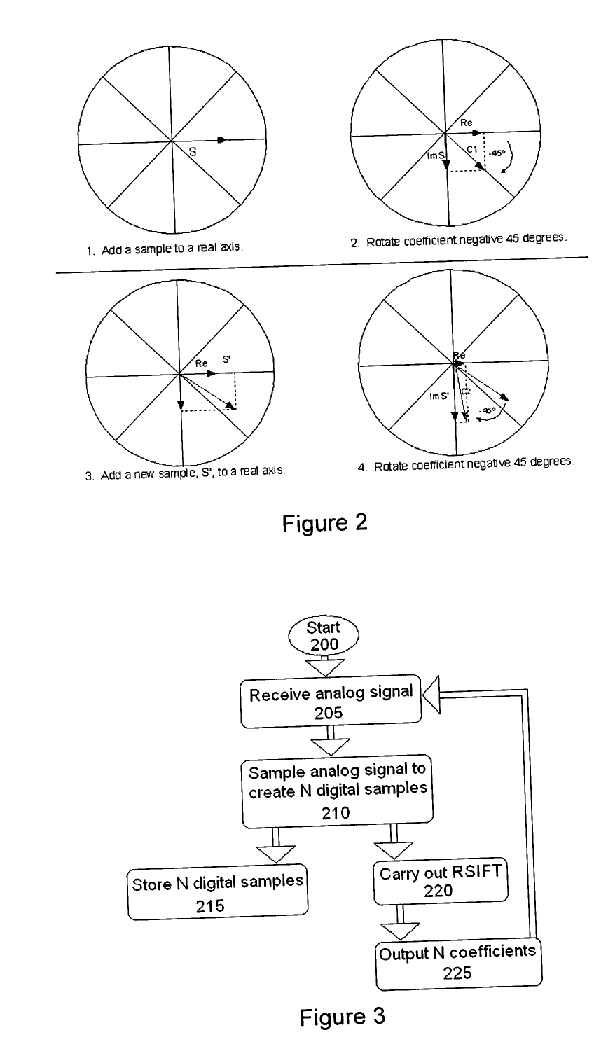

FIG. 8 is a flowchart illustrating RSIFT. First, a sample is collected from the signal, 10. Then the sample is added to all of the coefficient registers, 12. Alternatively, the signal may be sampled to collect samples prior to starting additions at 12. Next, the coefficient in each register is rotated backward by (2π)/N radians more than the previous coefficient register (i.e. (2nπt)/N radians), 14. This is done by subtracting an angle from each coefficient vector using the difference of two angles formula from trigonometry. After rotation, the angle of each coefficient will be normal. This is ready for the next sample to be added to all coefficients. If the last sample has not been reached, then the process returns to the sample collection; alternatively the calculation of the coefficients is completed, 16. After N cycles the classical transform results, and the coefficients values are output, 18. If less than all of the coefficients are of interest, then the samples will be added to only those coefficient registers, and only those coefficient registers will be rotated. FIG. 2 illustrates a rotation computation for N equal to eight.

FIG. 9 is a flowchart illustrating RSAFT. The complex Fourier Transform will be described here because real-valued samples are only a special case where the complex portion is zero. All coefficient registers are initially set to zero, and all previous samples may be considered to be zero. Each coefficient is defined as a complex number and considered as a vector with phase angle and magnitude. The first sample will then become the first of a set of N samples in which the last N-1 are zero. As illustrated a sample is collected from the signal, 20. Then the difference between this sample and the oldest sample is determined (if there is no oldest sample, zero is used), 22. The difference is then added to all of the coefficient registers, 24. Next, the coefficient in each register is rotated backward by (2π)/N radians more than the previous coefficient register (i.e. (2π)/N radians), 26. The updated coefficients values are output, 28, and the process returns back to collection of the next sample, 20. If less than all of the coefficients are of interest, then the samples will be added to only those coefficient registers, and only those coefficient registers will be rotated.

FIG. 3 is another flowchart illustrating RSAFT. This method starts at 200. Next, a signal, such as an analog signal, is received at 205. This signal is then sampled, creating a plurality N of digital samples, at 210. The digital samples may be stored, at 215, and at the same time (or before or after) RSIFT is carried out (for example, as shown in FIG. 8) to calculate the plurality N of coefficients, at 220. These coefficients may then output, for example to a network, channel or bus, at 225. The method may then be repeated using a new analog signal at 205.

The RSAFT process may not seem efficient because it has N-squared multiplies in each transform. However, this algorithm is optimum for a Programmable Logic Device (PLD), such as a Field Programmable Gate Array (FPGA) where N complex multiplies may be carried out in parallel. Accordingly, although the total number of calculations may be large, they may be carried out in parallel, allowing the results to be determined faster than other methods.

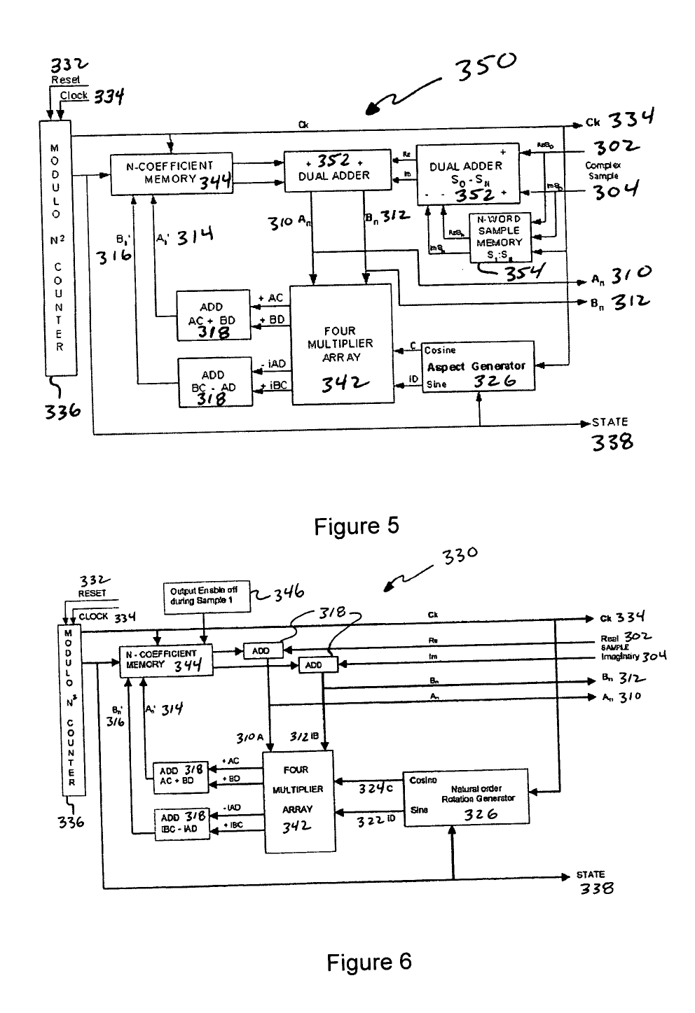

FIG. 5 shows an example of a process architecture 330 for rotational complex SIFT implementation. The current sample (having real portion 302 and imaginary portion 304) is added to each coefficient (by adders 318). The coefficients are then rotated by minus one unit of angle for its angular rate (using the sine 322 and cosine 324 generated by angle or rotation generator 326 together with a four multiplier array 342 and adders 318), to produce the rotated coefficients (having real portion 314 and imaginary portion 316) ready to be added with the next sample. After addition of the next sample (by adders 318) the desired coefficients (having real portion 310 and imaginary portion 312) are produced. The rotated coefficients may be stored (for example, in N-coefficient memory 344). The control is a binary counter (such as a modulo N² counter 336). The angle generator only needs to supply the sine and cosine of (2nπ/N) as n goes from 0 to (N/2−1) in natural order. The rotation is achieved by a complex multiplier (such as a four multiplier array 342) together with adders (318). All angle values may be stored as N/4 table entries or generated from a single complex seed. Also illustrated in FIG. 5 are reset 332, clock 334, both coupled to the control, as well as connection 346 to turn off the output during the first sample, and connection 338 for indicating the state. The total amount of hardware is very small. It is also an autonomous functional unit (AFU). In addition, clock pulses sent to an AFU need not be evenly spaced, for example each successive clock pulse may arrive after a shorter interval than the previous clock pulse, until an minimum clock pulse is achieved.

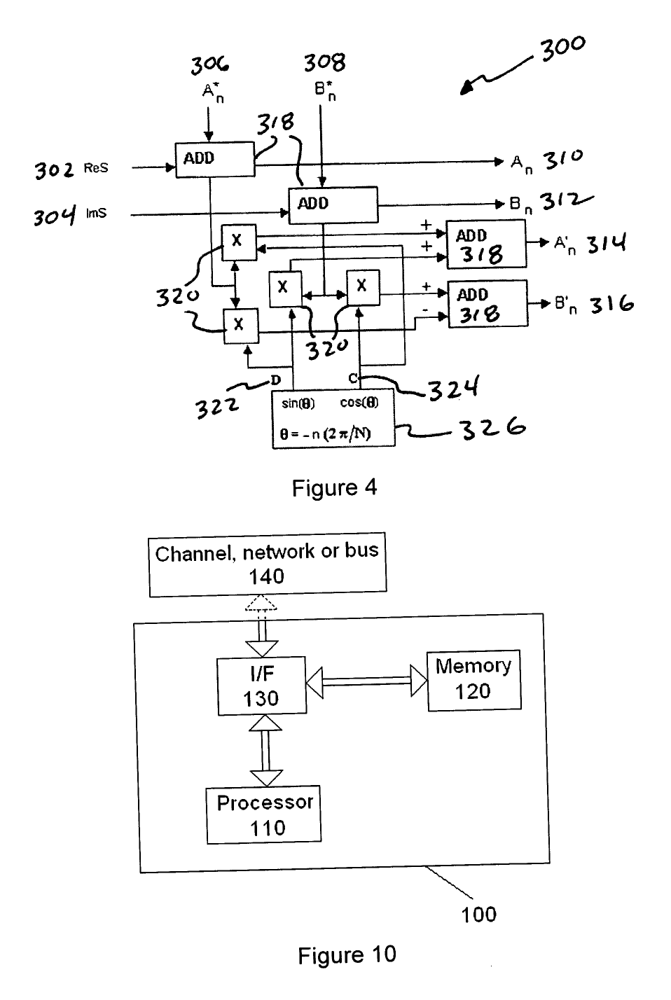

FIG. 4 shows the RSIFT atom network 300. In this figure, the complex multiplier is illustrated in more detail as a four multiplier array having multipliers 320. Also shown are the rotated coefficients from the previous cycle (having real portion 306 and imaginary portion 308) ready to be added with the next sample (designated as A*ₙ (real portion) and B*ₙ (imaginary portion) to distinguish them from the rotated coefficient from the current cycle which are designated as A′ₙ (real portion) and B′ₙ (imaginary portion)).

FIG. 6 shows an example of a process architecture for RSAFT for complex samples. This device is similar to that shown in FIG. 5, except for the use of a dual adder 352 in place of two of the adders 318 in FIG. 5, as well as an additional dual adder 352 and memory (such as an N-word sample memory 354).

The following is a detailed description of RSAFT, useful as a comparison with the earlier description of SAFT. It will be apparent to those of ordinary skill in the art that since the calculation using RSIFT or RSAFT when carried out in an actual device is not identical to the calculation using SIFT, the error in each coefficient (for example, rounding errors) will not be identical, and therefore the coefficients calculated using RSIFT (RSIFT coefficients) or RSAFT (RSAFT coefficients) will not be the same as those calculated using SIFT (SIFT coefficients).

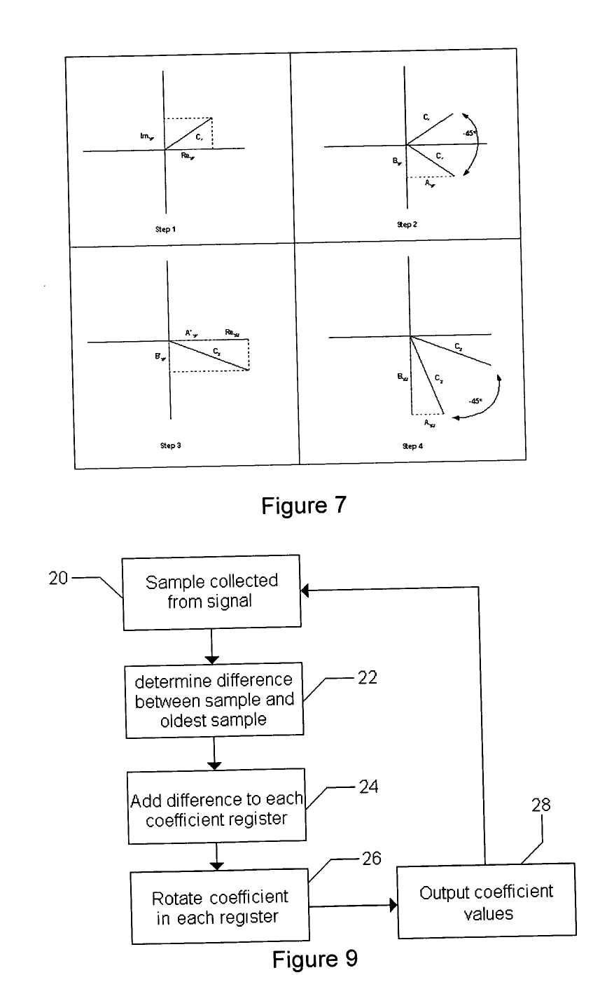

Each coefficient must be rotated counter-clockwise by increments of 360°/N times its appropriate frequency (rate) multiplier. FIG. 7 illustrates the details for N equal to eight. The base frequency, f₁ will therefore rotate at 360°/8=45° per sample-time. The higher multiples will rotate 90°, 135° and 180° respectively. When the first sample arrives, it is loaded into each coefficient and rotated through the angle appropriate to that coefficient. In the case of this example, the fundamental frequency coefficient vector is rotated by −45°, the second by −90°, the third by −135°, etc.

The real and imaginary components of the new coefficient vectors (C₁=A₁+jB₁, C₂=A₂+jB₂, etc.) are then stored. In this case, there are four coefficient vectors giving a total of eight independent coefficient values. When each new sample arrives, its complex components added to the corresponding components of the stored coefficient vectors and the sums are again rotated in natural order (by −45°, −90°, etc), thereby yielding the next set of subcoefficients. The set of subcoefficients for each frequency are thus treated as one complex vector. After N iterations, this procedure yields the Fourier Transform coefficients of the N samples.

Considerable computational advantage is gained from the fact that the process returns to the same point at the end of each cycle and iteratively uses the same set of trigonometric multipliers in the same order. The same physical hardware may be used for any N with accommodation required only in the counter and the number of registers involved.

An exemplary apparatus 100 embodiment comprises a processor 110, a memory 120, and a network or channel interface 130, as shown in FIG. 10. Depending upon the selected embodiment, the apparatus 100 may include other components; for example, when implemented as a wireless device, the apparatus may also include an antenna, a housing, a user interface (keypad, display, etc.), and so on, as known to those of skill in the art.

The interface (“I/F”) 130 is utilized for appropriate connection to a relevant channel, network or bus; for example, the interface 130 may provide impedance matching, drivers and other functions for a wireline interface, may provide demodulation, modulation, sampling, analog-to-digital (A/D) conversion and digital-to-analog (D/A) conversion for a wireless interface, and may provide a physical interface for the memory 120 with other devices. In general, the interface 130 is used to receive and transmit data, depending upon the selected embodiment, such as voice information, wireless signals, data, and other pertinent information.

The memory 120 may be an integrated circuit or portion of an integrated circuit, such as various forms of RAM, DRAM, SRAM, SDRAM, MRAM, FeRAM, ROM, EPROM, E²PROM, flash, and so on, or any other form of memory or storage device known or which will become known. For non-IC (or non-SOC) embodiments, the memory 120 may also be a magnetic (hard of floppy) drive, an optical storage device, or any other type of data storage apparatus, and also may be distributed across multiple devices.

The processor 110 may comprise a single processor or one or more processors. As the term processor is used herein, these implementations may include use of a single integrated circuit (“IC”), or may include use of a plurality of integrated circuits or other components connected, arranged or grouped together, such as microprocessors, digital signal processors (“DSPs”), parallel processors, multiple core processors, custom ICs, application specific integrated circuits (“ASICs”), field programmable gate arrays (“FPGAs”), programmable logic devices (“PLDS”), adaptive computing ICs, associated memory (such as RAM, DRAM and ROM), and other ICs and components. As a consequence, as used herein, the term processor should be understood to equivalently mean and include a single IC, or arrangement of custom ICs, ASICs, processors, microprocessors, controllers, FPGAs, PLDs, adaptive computing ICs, or some other grouping of integrated circuits which perform the functions discussed below, with associated memory, such as microprocessor memory or additional RAM, DRAM, SDRAM, SRAM, MRAM, ROM, EPROM or E²PROM. A processor (such as processor 110), with its associated memory, may be adapted or configured (via programming, FPGA interconnection, or hard-wiring) to perform the methodology of the invention, as discussed above and as further discussed below. For example, the methodology may be programmed and stored, in a processor 110 with its associated memory (and/or memory 120) and other equivalent components, as a set of program instructions (or equivalent configuration or other program) for subsequent execution when the processor is operative (i.e., powered on and functioning). Equivalently, when the processor 110 may be implemented in whole or part as FPGAs, custom ICs and/or ASICs, the FPGAs, custom ICs or ASICs also may be designed, configured and/or hard-wired to implement the methodology of the invention. For example, the processor 110 may implemented as an arrangement of microprocessors, DSPs and/or ASICs, collectively referred to as a “processor”, which are respectively programmed, designed, adapted or configured to implement the methodology of the invention.

More generally, the apparatus, methods, and programs of the present invention may be embodied in any number of forms, such as within any type of computer, within a workstation, within a server, within a computer network, within a computing device, within a communication device, or within any other form of computing, communication system which contains source code or is hard-wired or configured to execute the methodology of the invention, including the various processors mentioned above. Such source code further may be compiled into some form of instructions or object code (including assembly language instructions or configuration information). The software or source code of the present invention may be embodied as any type of source code, such as C, C++, FORTRAN, BASIC, SQL and its variations (e.g., SQL 99 or proprietary versions of SQL), Java, or any other type of programming language which performs the functionality discussed herein, including various hardware definition languages (e.g., Verilog), when embodied as an ASIC. As a consequence, a “construct”, “program construct”, “software construct” or “software”, as used herein, means and refers to any programming language, of any kind, with any syntax or signatures, which provides or can be interpreted to provide the associated functionality or methodology specified (when instantiated or loaded into a processor, including a processor 110.

The program instructions, software or other source code of the present invention and any resulting bit file (object code or configuration bit sequence) may be embodied within any tangible storage medium, such as within a memory or storage device for use by a computer, a workstation, any other machine-readable medium or form, or any other storage form or medium for use in a computing system. Such storage medium, memory or other storage devices may be any type of memory device, memory integrated circuit (“IC”), or memory portion of an integrated circuit (such as the resident memory within a processor IC), including without limitation RAM, FLASH, DRAM, SRAM, MRAM, FeRAM, ROM, EPROM or E²PROM, or any other type of memory, storage medium, or data storage apparatus or circuit, depending upon the selected embodiment, as discussed above. For example, without limitation, a tangible medium storing computer readable metadata or software, or other machine-readable medium, may include a floppy disk, a CDROM, a CD-RW, a magnetic hard drive, an optical drive, a quantum computing storage medium or device, a transmitted electromagnetic signal (e.g., used in internet downloading), or any other type of data storage apparatus or medium.

### EXAMPLE

### Numerical Example of Rotational SIFT and SAFT for Sixteen Real Samples and the Calculations Arranged According to the Molecular Architecture

Given the 17 real samples [V0:V16], the vector: T7 carries the 16 last samples for a verification transform All of the Fast Fourier Transform classical coefficients are correctly generated using the transforms and the sample difference. (n) is the frequency identifier, (n=0) is DC. The base frequency is (n=1). The reference rotates backward by a fixed amount per sample. This angular rate increases with the frequency coefficient number “n”. The variables match the architecture in the figures. The sample values may be edited. N/2-frequencies are used. N/2−1 rotate-adds are used per sample.

| | | | | |
|---|---|---|---|---|
| The Variables match the | V0 := .1 | V15 := .31 | V10 := .16 | V11 := .2 |
| architecture in the | V4 := .4 | V12 := .12 | V5 := −.22 | V8 := .13 |
| figures. A normalization | V2 := .5 | V13 := .15 | V6 := −.66 | V9 := .33 |
| constant, M is required | V3 := .1 | V14 := .04 | V7 := −.11 | V1 := .33 |
| to match the transforms. | | V16 := .222 | | |
| M := 4 | | | | |
| The number of points is: | | | | |

First we must know the sines and cosines of the N/2 angles (En): We will represent the sines as D0 through D8 and the cosines as C0 through εθr N=16 the first angle is −π/8 radians which is −22.5 degrees To rotate the reference backward and leave the coefficients in their initial positions we must use increments of n*(−22.5) degrees.

$$C0 := cos ( 0 ) C1 := cos ( \frac{- x}{8} ) C2 := cos ( \frac{- x}{4} ) C3 := cos ( \frac{- 3 x}{8} )$$

$$C4 := cos ( \frac{- x}{2} ) C5 := cos ( \frac{- 6 \cdot x}{8} ) C6 := cos ( \frac{- 3 \cdot x}{4} ) C7 := cos ( \frac{- 7 x}{8} )$$

$$C0 = 1 C1 = 0.92388 C2 = 0.707107 C3 = 0.382683 C4 = 0$$

$$C5 = - 0.382683 C6 = - 0.707107 C7 = - 0.92388$$

$$D0 := sin ( 0 ) D1 := sin ( \frac{- x}{8} ) D2 := sin ( \frac{- x}{4} ) D3 := sin ( \frac{- 3 \cdot x}{8} )$$

$$D4 := sin ( \frac{- x}{2} ) D5 := sin ( \frac{- 6 \cdot x}{8} ) D6 := sin ( \frac{- 3 \cdot x}{4} ) D7 := sin ( \frac{- 7 x}{8} )$$

$$D0 = 0 D1 = - 0.382683 D2 = - 0.707107 D3 = - 0.92388 D4 = - 1$$

$$D5 = - 0.92388 D6 = - 0.707107 D7 = - 0.382683$$

$$T17 := ( \begin{matrix}V16 \\ V15 \\ V14 \\ V13 \\ V12 \\ V11 \\ V10 \\ V9 \\ V8 \\ V7 \\ V6 \\ V5 \\ V4 \\ V3 \\ V2 \\ V1\end{matrix} )$$

The rotational SIFT and SAFT computatons are shown in full detail below. A and B are [symbol] then dBₙ of the classical Fast Fourier Transform. The number of rotate-add cycles per sample is reduced from N to N/2—

Declairations and initializatons:

| | | | | | | | | |
|---|---|---|---|---|---|---|---|---|
| A0 := 0 | A1 := 0 | A2 := 0 | A3 := 0 | A4 := 0 | A5 := 0 | A6 := 0 | A7 := 0 | A8 := 0 |
| | B1 := 0 | B2 := 0 | B3 := 0 | B4 := 0 | B5 := 0 | B6 := 0 | B7 := 0 | |

| | | SAMPLE INPUT: | |
|---|---|---|---|
| | | S := 0 | S = 0 |
| ROTATE THE COEFFICIENTS | | ADD NEW SAMPLE | |
| | | A₀ := A0 + S | A₈ := A8 − S |
| | | A₁ := A1 + S | B₁ := B1 |
| | | A₂ := A2 + S | B₂ := B2 |
| | | A₃ := A3 + S | B₃ := B3 |
| | | A₄ := A4 + S | B₄ := B4 |
| | | A₅ := A5 + S | B₅ := B5 |
| | | A₆ := A6 + S | B₆ := B6 |
| | | A₇ := A7 + S | B₇ := B7 |
| | | S := V0 | S = 0.1 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V1 | S = 0.33 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V2 | S = 0.5 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V3 | S = 0.1 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V4 | S = 0.4 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V5 | S = −0.22 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V6 | S = −0.66 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V7 | S = −0.11 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V8 | S = 0.13 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V9 | S = 0.33 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V10 | S = 0.16 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V11 | S = 0.2 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V12 | S = 0.12 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V13 | S = 0.15 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V14 | S = 0.04 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V15 | S = 0.31 |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |

Note:
For Sliding Aperature it is required to subtract the N-ago sample. The first such case
follows.

| | | Find the difference: | |
|---|---|---|---|
| | | S := V16 − V0 | S = 0.122 |
| | | Apply to sample: | |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |

$$FT := {( \begin{matrix}{A}_{0} \\ {A}_{1} + {B}_{1} \cdot i \\ {A}_{2} + {B}_{2} \cdot i \\ {A}_{3} + {B}_{3} \cdot i \\ {A}_{4} + {B}_{4} \cdot i \\ {A}_{5} + {B}_{5} \cdot i \\ {A}_{6} + {B}_{6} \cdot i \\ {A}_{7} + {B}_{7} \cdot i \\ {A}_{8}\end{matrix} )}^{\begin{matrix}\begin{matrix}This loads the \\ results into the \\ Matrix FT .\end{matrix} \\ \end{matrix}} FT = {( \begin{matrix}2.002 \\ 1.319 + 0.570 i \\ 0.277 - 1.867 i \\ - 0.732 + 0.743 i \\ 0.832 - 0.090 i \\ - 0.555 - 0.326 i \\ - 0.613 + 0.693 i \\ 0.336 + 0.620 i \\ - 0.178\end{matrix} )}^{\begin{matrix}\begin{matrix}This loads the results \\ from the program into \\ the matrix FT which \\ matches the MathCAD \\ output format for \\ comparison .\end{matrix} \\ \end{matrix}}$$

$$FFT = {( \begin{matrix}2.002 \\ 1.319 + 0.570 i \\ 0.277 - 1.867 i \\ - 0.732 + 0.743 i \\ 0.832 - 0.090 i \\ - 0.555 - 0.326 i \\ - 0.613 + 0.693 i \\ 0.336 + 0.620 i \\ - 0.178\end{matrix} )}^{\begin{matrix}\begin{matrix}Normalize MathCAD \\ computation of the fft . \\ FFT := fft ( T17 ) \cdot M \\ This is the normalized \\ FFT matrix :\end{matrix} \\ \end{matrix}} FFT - FT = {( \begin{matrix}0 \\ 0 - 0 i \\ 0 - 0 i \\ - 0 + 0 i \\ 0 \\ - 0 + 0 i \\ - 0 + 0 i \\ 0 - 0 i \\ 0\end{matrix} )}^{\begin{matrix}Error matrix . \\ \end{matrix}}$$

$$CFFT := cfft ( T 17 ) \cdot M$$

$$CFT := {( \begin{matrix}{A}_{0} \\ {A}_{1} + {B}_{1} \cdot i \\ {A}_{2} + {B}_{2} \cdot i \\ {A}_{3} + {B}_{3} \cdot i \\ {A}_{4} + {B}_{4} \cdot i \\ {A}_{5} + {B}_{5} \cdot i \\ {A}_{6} + {B}_{6} \cdot i \\ {A}_{7} + {B}_{7} \cdot i \\ {A}_{8} \\ {A}_{7} - {B}_{7} \cdot i \\ {A}_{6} - {B}_{6} \cdot i \\ {A}_{5} - {B}_{5} \cdot i \\ {A}_{4} - {B}_{4} \cdot i \\ {A}_{3} - {B}_{3} \cdot i \\ {A}_{2} - {B}_{2} \cdot i \\ {A}_{1} - {B}_{1} \cdot i\end{matrix} ) }^{\begin{matrix}\underline{Input Matrix} \\ \end{matrix}} CFT = {( \begin{matrix}2.002 \\ 1.319 + 0.57 i \\ 0.277 - 1.867 i \\ - 0.732 + 0.743 i \\ 0.832 - 0.09 i \\ - 0.555 - 0.326 i \\ - 0.613 + 0.693 i \\ 0.336 + 0.62 i \\ - 0.178 \\ 0.336 - 0.62 i \\ - 0.613 - 0.693 i \\ - 0.555 + 0.326 i \\ 0.832 + 0.09 i \\ - 0.732 - 0.743 i \\ 0.277 + 1.867 i \\ 1.319 - 0.57 i\end{matrix} )}^{\begin{matrix}\underline{SAFT Solution} \\ \end{matrix}}$$

$$CFFT = {( \begin{matrix}2.002 \\ 1.319 + 0.57 i \\ 0.277 - 1.867 i \\ - 0.732 + 0.743 i \\ 0.832 - 0.09 i \\ - 0.555 - 0.326 i \\ - 0.613 + 0.693 i \\ 0.336 + 0.62 i \\ - 0.178 \\ 0.336 - 0.62 i \\ - 0.613 - 0.693 i \\ - 0.555 + 0.326 i \\ 0.832 + 0.09 i \\ - 0.732 - 0.743 i \\ 0.277 + 1.867 i \\ 1.319 - 0.57 i\end{matrix} )}^{\begin{matrix}\underline{Complex FT} \\ \end{matrix}} CFT - CFFT = {( \begin{matrix}0 \\ 0 \\ - 0 \\ 0 \\ 0 \\ 0 \\ 0 \\ 0 \\ 0 \\ 0 \\ 0 \\ 0 \\ 0 \\ 0 \\ - 0 \\ 0\end{matrix} )}^{\begin{matrix}\underline{Error Matrix} \\ \end{matrix}}$$

### Numerical Example of Rotational SIFT and SAFT for Sixteen Complex Samples an the Calculations Arranged According to the Molecular Architecture

Given the 17 complex samples [V0:V16], the vector: T7 carries the 16 last samples for a verification transform. All of the Fast Fourier Transform classical coefficients are correctly generated using the transforms and the sample difference. (n) is the frequency identifier, (n=0) is DC. The base frequency is (n=1). The reference rotates backward by a fixed amount per sample. This angular rate increases with the frequency coefficient number “n”. The variables match the architecture in the figures. The sample values may be edited. N/2−1 frequencies are used. N/2−1 rotate-adds are used per sample.

| | | | | |
|---|---|---|---|---|
| The Variables match the | V0 := .1 + .1 · i | V5 := .22 − .45 · i | V4 := .4 + .6 · i | V12 := .12 − .4 · i |
| architecture in the | V1 := .33 + .2 · i | V6 := .66 + .6 · i | V7 := −.11 + .8 · i | V13 := .15 + .38 · i |
| figures. A normalization | V2 := .5 − .11 · i | V10 := .16 + .22 · i | V8 := .13 − .55 · i | V14 := .04 − .111 · i |
| constant, M is required | V3 := .1 − .9 · i | V11 := .2 − .75 · i | V9 := .33 − 05 · i | V15 := .31 − .5 · i |
| to match the transforms. | | V16 := 1 + i | | |
| M := 4 | | | | |
| The number of points is: | | | | |

First we must know the sines and cosines of the N/2 angles (En):We will represent the sines as D0 through D8 and the cosines as C0 through εθr N=16 the first angle is −π/8 radians which is −22.5 degrees To rotate the reference backward and leave the coefficients in their initial positions we must use increments of n*(−22.5) degrees.

$$C 0 \text{:} = cos ( 0 ) C 1 \text{:} = cos ( \frac{- x}{8} ) C 2 \text{:} = cos ( \frac{- x}{4} ) C 3 \text{:} = cos ( \frac{- 3 x}{8} )$$

$$C 4 \text{:} = cos ( \frac{- x}{2} ) C 5 \text{:} = cos ( \frac{- 5 \cdot x}{8} ) C 6 \text{:} = cos ( \frac{- 3 \cdot x}{4} ) C 7 \text{:} = cos ( \frac{- 7 x}{8} )$$

$$D 0 \text{:} = sin ( 0 ) D 1 \text{:} = sin ( \frac{- x}{8} ) D 2 \text{:} = sin ( \frac{- x}{4} ) D 3 \text{:} = sin ( \frac{- 3 \cdot x}{8} )$$

$$D 4 \text{:} = sin ( \frac{- x}{2} ) D 5 \text{:} = sin ( \frac{- 6 \cdot x}{8} ) D 6 \text{:} = sin ( \frac{- 3 \cdot x}{4} ) D 7 \text{:} = sin ( \frac{- 7 x}{8} )$$

$$T 17 := ( \begin{matrix}V 16 \\ V 15 \\ V 14 \\ V 13 \\ V 12 \\ V 11 \\ V 10 \\ V 9 \\ V 8 \\ V 7 \\ V 6 \\ V 5 \\ V 4 \\ V 3 \\ V 2 \\ V 1\end{matrix} )$$

$$\begin{matrix} C 0 = 1 & C 4 = 0 & D 0 = 0 & D 4 = - 1 \\ C 1 = 0.92388 & C 5 = - 0.382683 & D 1 = - 0.382683 & D 5 = - 0.92388 \\ C 2 = 0.707107 & C 6 = - 0.707107 & D 2 = - 0.707107 & D 6 = - 0.707107 \\ C 3 = 0.382683 & C 7 = - 0.92388 & D 3 = - 0.92388 & D 7 = - 0.382683\end{matrix}$$

The rotational SIFT and SAFT computatons are shown in full detail below. A and B are [symbol] then dBₙ of the classical Fast Fourier Transform. The number of rotate-add cycles per sample is reduced from N to N/2—

Declairations and initializatons:

| | | | | | | | | |
|---|---|---|---|---|---|---|---|---|
| A0 := 0 | A1 := 0 | A2 := 0 | A3 := 0 | A4 := 0 | A5 := 0 | A6 := 0 | A7 := 0 | A8 := 0 |
| | B1 := 0 | B2 := 0 | B3 := 0 | B4 := 0 | B5 := 0 | B6 := 0 | B7 := 0 | |

| | | SAMPLE INPUT: | |
|---|---|---|---|
| | | S := 0 | S = 0 |
| ROTATE THE COEFFICIENTS | | ADD NEW SAMPLE | |
| | | A₀ := A0 + S | A₈ := A8 − S |
| | | A₁ := A1 + S | B₁ := B1 |
| | | A₂ := A2 + S | B₂ := B2 |
| | | A₃ := A3 + S | B₃ := B3 |
| | | A₄ := A4 + S | B₄ := B4 |
| | | A₅ := A5 + S | B₅ := B5 |
| | | A₆ := A6 + S | B₆ := B6 |
| | | A₇ := A7 + S | B₇ := B7 |
| | | S := V0 | S = 0.1 + 0.1i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V1 | S = 0.33 + 0.2i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V2 | S = 0.5 − 0.11i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V3 | S = 0.1 − 0.9i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V4 | S = 0.4 + 0.6i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V5 | S = −0.22 − 0.45i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V6 | S = −0.66 + 0.6i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V7 | S = −0.11 + 0.8i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V8 | S = 0.13 − 0.55i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V9 | S = 0.33 − 0.05i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V10 | S = 0.16 + 0.22i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V11 | S = 0.2 − 0.75i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V12 | S = 0.12 − 0.4i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V13 | S = 0.15 + 0.38i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V14 | S = 0.04 − 0.111i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |
| | | S := V15 | S = 0.31 − 0.5i |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |

Note:
For Sliding Aperature it is required to subtract the N-ago sample. The first such case
follows.

| | | Find the difference: | |
|---|---|---|---|
| | | S := V16 − V0 | S = 0.9 + 0.9i |
| | | Apply to sample: | |
| A0 := A₀ | A8 := −A₈ | A₀ := A0 + S | A₈ := A8 − S |
| A1 := A₁ · C1 + B₁ · D1 | B1 := B₁ · C1 − A₁ · D1 | A₁ := A1 + S | B₁ := B1 |
| A2 := A₂ · C2 + B₂ · D2 | B2 := B₂ · C2 − A₂ · D2 | A₂ := A2 + S | B₂ := B2 |
| A3 := A₃ · C3 + B₃ · D3 | B3 := B₃ · C3 − A₃ · D3 | A₃ := A3 + S | B₃ := B3 |
| A4 := A₄ · C4 + B₄ · D4 | B4 := B₄ · C4 − A₄ · D4 | A₄ := A4 + S | B₄ := B4 |
| A5 := A₅ · C5 + B₅ · D5 | B5 := B₅ · C5 − A₅ · D5 | A₅ := A5 + S | B₅ := B5 |
| A6 := A₆ · C6 + B₆ · D6 | B6 := B₆ · C6 − A₆ · D6 | A₆ := A6 + S | B₆ := B6 |
| A7 := A₇ · C7 + B₇ · D7 | B7 := B₇ · C7 − A₇ · D7 | A₇ := A7 + S | B₇ := B7 |

$$FT := {( \begin{matrix}{A}_{0} \\ {A}_{1} + {B}_{1} \cdot i \\ {A}_{2} + {B}_{2} \cdot i \\ {A}_{3} + {B}_{3} \cdot i \\ {A}_{4} + {B}_{4} \cdot i \\ {A}_{5} + {B}_{5} \cdot i \\ {A}_{6} + {B}_{6} \cdot i \\ {A}_{7} + {B}_{7} \cdot i \\ {A}_{8}\end{matrix} )}^{\begin{matrix}\begin{matrix}This loads the \\ results into the \\ Matrix FT .\end{matrix} \\ \end{matrix}} FT = {( \begin{matrix}2.780 - 0.021 i \\ 3.054 + 0.674 i \\ - 0.547 - 0.082 i \\ 1.122 + 1.999 i \\ 3.040 - 0.039 i \\ 2.761 + 2.990 i \\ - 0.680 - 0.591 i \\ - 0.468 + 2.144 i \\ 0.600 + 2.519 i\end{matrix} )}^{\begin{matrix}\begin{matrix}This loads the results \\ from the program into \\ the matrix FT which \\ matches the MathCAD \\ output format for \\ comparison .\end{matrix} \\ \end{matrix}}$$

$${FFT = FFT}^{\begin{matrix}\begin{matrix}Normalize MathCAD \\ computation of the fft . \\ FFT := fft ( T 17 ) \cdot M \\ This is the normalized \\ FFT matrix \text{:}\end{matrix} \\ \end{matrix}} { FFT - FT = s}^{\begin{matrix} Error matrix . \\ \end{matrix}}$$

$$CFFT := cfft ( T 17 ) \cdot M$$

$$CFT := {( \begin{matrix}{A}_{0} \\ {A}_{1} + {B}_{1} \cdot i \\ {A}_{2} + {B}_{2} \cdot i \\ {A}_{3} + {B}_{3} \cdot i \\ {A}_{4} + {B}_{4} \cdot i \\ {A}_{5} + {B}_{5} \cdot i \\ {A}_{6} + {B}_{6} \cdot i \\ {A}_{7} + {B}_{7} \cdot i \\ {A}_{8} \\ {A}_{7} - {B}_{7} \cdot i \\ {A}_{6} - {B}_{6} \cdot i \\ {A}_{5} - {B}_{5} \cdot i \\ {A}_{4} - {B}_{4} \cdot i \\ {A}_{3} - {B}_{3} \cdot i \\ {A}_{2} - {B}_{2} \cdot i \\ {A}_{1} - {B}_{1} \cdot i\end{matrix} ) }^{\begin{matrix}\underline{Input Matrix} \\ \end{matrix}} CFT = {( \begin{matrix}2.78 - 0.021 i \\ 3.054 + 0.674 i \\ - 0.547 - 0.082 i \\ 1.122 + 1.999 i \\ 3.04 - 0.039 i \\ 2.761 + 2.99 i \\ - 0.68 - 0.591 i \\ - 0.468 + 2.144 i \\ 0.6 + 2.519 i \\ 2.696 + 0.903 i \\ 1.009 - 1.978 i \\ - 2.314 + 3.643 i \\ 0.18 + 0.141 i \\ - 1.031 + 0.513 i \\ 2.658 + 3.651 i \\ 1.14 - 0.465 i\end{matrix} )}^{\begin{matrix}\underline{SAFT Solution} \\ \end{matrix}}$$

$$CFFT = {( \begin{matrix}2.78 - 0.021 i \\ 3.054 + 0.674 i \\ - 0.547 - 0.082 i \\ 1.122 + 1.999 i \\ 3.04 - 0.039 i \\ 2.761 + 2.99 i \\ - 0.68 - 0.591 i \\ - 0.468 + 2.144 i \\ 0.6 + 2.519 i \\ 2.696 + 0.903 i \\ 1.009 - 1.978 i \\ - 2.314 + 3.643 i \\ 0.18 + 0.141 i \\ - 1.031 + 0.513 i \\ 2.658 + 3.651 i \\ 1.14 - 0.465 i\end{matrix} )}^{\begin{matrix}\underline{Complex FT} \\ \end{matrix}} CFT - CFFT = {( \begin{matrix}0 \\ 0 \\ 0 \\ 0 \\ 0 \\ 0 \\ - 0 + 0 i \\ 0 i \\ 0 \\ 0 i \\ 0 \\ - 0 i \\ 0 \\ - 0 \\ - 0 + 0 i \\ 0\end{matrix} )}^{\begin{matrix}\underline{Error Matrix} \\ \end{matrix}}$$

### This Calculates the SINE and COSINE Values in Natural Order Using the Exsting Architecture of the SAFT Processor

This process provides the same number of steps per complete cycle as input parameter “N”. It requires the processor to know the correct value of sin (2π/N) and cos (2π/N). The example assumes that there is a ROM which provides the values of sine and cosine. The processor intiallizes the values of sin(0) and cos(0). The computation uses a formula for sin(α+β) and cos(α+β) which calculates in the same architecture as is used to generate the rotational SAFT. The process given herein uses the single entry to generate the entire set of N pairs of sine and cosine values in natural order, which is the only order required by the RSAFT.

The N pairs of sine and cosine values are generated by repetitively adding to the angle until a full set of functions is obtained. The first angle α is ZERO. The angle β=2π/N is then added to it and its sine and cosine are stored. The resulting sine-cosine pairs repeatedly becomes the new α and the value of β is again added. In this manner the process can populate the RAM with the necessary arguments to support the computations for all values of N.

Alternatively, the values of sine and/or cosine can be supplied from external input either as seed or the complete table. Of course it is also possible to simply store all desired tables in a large ROM.

Because the transfer of the Fourier Transform processor from one value of N to another requires the setting of other register taps and counter settings, it is efficient to reuse the computational element in this manner.

Being able to use a system to generate Fourier Transforms of somewhat arbitrary sample lengths permits the support of many protocols without parallel and redundant systems.

$$x := 0 , 1 … 64 y ( x ) := cos ( x \cdot \frac{2 π}{64} ) z ( x ) := sin ( x \cdot \frac{2 π}{64} )$$

N := 64
$v := \frac{2 \cdot π}{N}$
v := 0.098

| | | | |
|---|---|---|---|
| Sine of ZERO | A := 0 | C := cos(v) | C = 0.9951847267 |
| Cosine of ZERO | B := 1 | D := sin(v) | D = 0.0980171403 |

| | | | | | | | |
|---|---|---|---|---|---|---|---|
| | | | | | | | x := 0 |
| A1 := D · B + C · A | B1 := CB − D · A | A := A1 | B := B1 | A = 0.098 | B = 0.995 | x := x + 1 | x = 1 |
| A1 := D · B + C · A | B1 := CB − D · A | A := A1 | B := B1 | A = 0.195 | B = 0.981 | x := x + 1 | x = 2 |
| A1 := D · B + C · A | B1 := CB − D · A | A := A1 | B := B1 | A = 0.29 | B = 0.957 | x := x + 1 | x = 3 |
| A1 := D · B + C · A | B1 := CB − D · A | A := A1 | B := B1 | A = 0.383 | B = 0.924 | x := x + 1 | x = 4 |
| A1 := D · B + C · A | B1 := CB − D · A | A := A1 | B := B1 | A = 0.471 | B = 0.882 | x := x + 1 | x = 5 |
| A1 := D · B + C · A | B1 := CB − D · A | A := A1 | B := B1 | A = 0.556 | B = 0.831 | x := x + 1 | x = 6 |
| A1 := D · B + C · A | B1 := CB − D · A | A := A1 | B := B1 | A = 0.634 | B = 0.773 | x := x + 1 | x = 7 |
| A1 := D · B + C · A | B1 := CB − D · A | A := A1 | B := B1 | A = 0.707 | B = 0.707 | x := x + 1 | x = 8 |
| A1 := D · B + C · A | B1 := CB − D · A | A := A1 | B := B1 | A = 0.773 | B = 0.634 | x := x + 1 | x = 9 |
| A1 := D · B + C · A | B1 := CB − D · A | A := A1 | B := B1 | A = 0.831 | B = 0.556 | x := x + 1 | x = 10 |
| A1 := D · B + C · A | B1 := CB − D · A | A := A1 | B := B1 | A = 0.882 | B = 0.471 | x := x + 1 | x = 11 |
| A1 := D · B + C · A | B1 := CB − D · A | A := A1 | B := B1 | A = 0.924 | B = 0.383 | x := x + 1 | x = 12 |
| A1 := D · B + C · A | B1 := CB − D · A | A := A1 | B := B1 | A = 0.957 | B = 0.29 | x := x + 1 | x = 13 |
| A1 := D · B + C · A | B1 := CB − D · A | A := A1 | B := B1 | A = 0.981 | B = 0.195 | x := x + 1 | x = 14 |
| A1 := D · B + C · A | B1 := CB − D · A | A := A1 | B := B1 | A = 0.995 | B = 0.098 | x := x + 1 | x = 15 |
| A1 := D · B + C · A | B1 := CB − D · A | A := A1 | B := B1 | A = 1 | B = 0 | x := x + 1 | x = 16 |
| A1 := D · B + C · A | B1 := CB − D · A | A := A1 | B := B1 | A = 0.995 | B = −0.098 | x := x + 1 | x = 17 |
| A1 := D · B + C · A | B1 := CB − D · A | A := A1 | B := B1 | A = 0.981 | B = −0.195 | x := x + 1 | x = 18 |
| A1 := D · B + C · A | B1 := CB − D · A | A := A1 | B := B1 | A = 0.957 | B = −0.29 | x := x + 1 | x = 19 |
| A1 := D · B + C · A | B1 := CB − D · A | A := A1 | B := B1 | A = 0.924 | B = −0.383 | x := x + 1 | x = 20 |
| A1 := D · B + C · A | B1 := CB − D · A | A := A1 | B := B1 | A = 0.882 | B = −0.471 | x := x + 1 | x = 21 |
| A1 := D · B + C · A | B1 := CB − D · A | A := A1 | B := B1 | A = 0.831 | B = −0.556 | x := x + 1 | x = 22 |
| A1 := D · B + C · A | B1 := CB − D · A | A := A1 | B := B1 | A = 0.773 | B = −0.634 | x := x + 1 | x = 23 |
| A1 := D · B + C · A | B1 := CB − D · A | A := A1 | B := B1 | A = 0.707 | B = −0.707 | x := x + 1 | x = 24 |
| A1 := D · B + C · A | B1 := CB − D · A | A := A1 | B := B1 | A = 0.634 | B = −0.773 | x := x + 1 | x = 25 |
| A1 := D · B + C · A | B1 := CB − D · A | A := A1 | B := B1 | A = 0.556 | B = −0.831 | x := x + 1 | x = 26 |
| A1 := D · B + C · A | B1 := CB − D · A | A := A1 | B := B1 | A = 0.471 | B = −0.882 | x := x + 1 | x = 27 |
| A1 := D · B + C · A | B1 := CB − D · A | A := A1 | B := B1 | A = 0.383 | B = −0.924 | x := x + 1 | x = 28 |
| A1 := D · B + C · A | B1 := CB − D · A | A := A1 | B := B1 | A = 0.29 | B = −0.957 | x := x + 1 | x = 29 |
| A1 := D · B + C · A | B1 := CB − D · A | A := A1 | B := B1 | A = 0.195 | B = −0.981 | x := x + 1 | x = 30 |
| A1 := D · B + C · A | B1 := CB − D · A | A := A1 | B := B1 | A = 0.098 | B = −0.995 | x := x + 1 | x = 31 |
| A1 := D · B + C · A | B1 := CB − D · A | A := A1 | B := B1 | A = 0 | B = −1 | x := x + 1 | x = 32 |
| A1 := D · B + C · A | B1 := CB − D · A | A := A1 | B := B1 | A = −0.098 | B = −0.995 | x := x + 1 | x = 33 |
| A1 := D · B + C · A | B1 := CB − D · A | A := A1 | B := B1 | A = −0.195 | B = −0.981 | x := x + 1 | x = 34 |
| A1 := D · B + C · A | B1 := CB − D · A | A := A1 | B := B1 | A = −0.29 | B = −0.957 | x := x + 1 | x = 35 |
| A1 := D · B + C · A | B1 := CB − D · A | A := A1 | B := B1 | A = −0.383 | B = −0.924 | x := x + 1 | x = 36 |
| A1 := D · B + C · A | B1 := CB − D · A | A := A1 | B := B1 | A = −0.471 | B = −0.882 | x := x + 1 | x = 37 |
| A1 := D · B + C · A | B1 := CB − D · A | A := A1 | B := B1 | A = −0.556 | B = −0.831 | x := x + 1 | x = 38 |
| A1 := D · B + C · A | B1 := CB − D · A | A := A1 | B := B1 | A = −0.634 | B = −0.773 | x := x + 1 | x = 39 |
| A1 := D · B + C · A | B1 := CB − D · A | A := A1 | B := B1 | A = −0.707 | B = −0.707 | x := x + 1 | x = 40 |
| A1 := D · B + C · A | B1 := CB − D · A | A := A1 | B := B1 | A = −0.773 | B = −0.634 | x := x + 1 | x = 41 |
| A1 := D · B + C · A | B1 := CB − D · A | A := A1 | B := B1 | A = −0.831 | B = −0.556 | x := x + 1 | x = 42 |
| A1 := D · B + C · A | B1 := CB − D · A | A := A1 | B := B1 | A = −0.882 | B = −0.471 | x := x + 1 | x = 43 |
| A1 := D · B + C · A | B1 := CB − D · A | A := A1 | B := B1 | A = −0.924 | B = −0.383 | x := x + 1 | x = 44 |
| A1 := D · B + C · A | B1 := CB − D · A | A := A1 | B := B1 | A = −0.957 | B = −0.29 | x := x + 1 | x = 45 |
| A1 := D · B + C · A | B1 := CB − D · A | A := A1 | B := B1 | A = −0.981 | B = −0.195 | x := x + 1 | x = 46 |
| A1 := D · B + C · A | B1 := CB − D · A | A := A1 | B := B1 | A = −0.995 | B = −0.098 | x := x + 1 | x = 47 |
| A1 := D · B + C · A | B1 := CB − D · A | A := A1 | B := B1 | A = −1 | B = 0 | x := x + 1 | x = 48 |
| A1 := D · B + C · A | B1 := CB − D · A | A := A1 | B := B1 | A = −0.995 | B = 0.098 | x := x + 1 | x = 49 |
| A1 := D · B + C · A | B1 := CB − D · A | A := A1 | B := B1 | A = −0.981 | B = 0.195 | x := x + 1 | x = 50 |
| A1 := D · B + C · A | B1 := CB − D · A | A := A1 | B := B1 | A = −0.957 | B = 0.29 | x := x + 1 | x = 51 |
| A1 := D · B + C · A | B1 := CB − D · A | A := A1 | B := B1 | A = −0.924 | B = 0.383 | x := x + 1 | x = 52 |
| A1 := D · B + C · A | B1 := CB − D · A | A := A1 | B := B1 | A = −0.882 | B = 0.471 | x := x + 1 | x = 53 |
| A1 := D · B + C · A | B1 := CB − D · A | A := A1 | B := B1 | A = −0.831 | B = 0.556 | x := x + 1 | x = 54 |
| A1 := D · B + C · A | B1 := CB − D · A | A := A1 | B := B1 | A = −0.773 | B = 0.634 | x := x + 1 | x = 55 |
| A1 := D · B + C · A | B1 := CB − D · A | A := A1 | B := B1 | A = −0.707 | B = 0.707 | x := x + 1 | x = 56 |
| A1 := D · B + C · A | B1 := CB − D · A | A := A1 | B := B1 | A = −0.634 | B = 0.773 | x := x + 1 | x = 57 |
| A1 := D · B + C · A | B1 := CB − D · A | A := A1 | B := B1 | A = −0.556 | B = 0.831 | x := x + 1 | x = 58 |
| A1 := D · B + C · A | B1 := CB − D · A | A := A1 | B := B1 | A = −0.471 | B = 0.882 | x := x + 1 | x = 59 |
| A1 := D · B + C · A | B1 := CB − D · A | A := A1 | B := B1 | A = −0.383 | B = 0.924 | x := x + 1 | x = 60 |
| A1 := D · B + C · A | B1 := CB − D · A | A := A1 | B := B1 | A = −0.29 | B = 0.957 | x := x + 1 | x = 61 |
| A1 := D · B + C · A | B1 := CB − D · A | A := A1 | B := B1 | A = −0.195 | B = 0.981 | x := x + 1 | x = 62 |
| A1 := D · B + C · A | B1 := CB − D · A | A := A1 | B := B1 | A = −0.098 | B = 0.995 | x := x + 1 | x = 63 |
| A1 := D · B + C · A | B1 := CB − D · A | A := A1 | B := B1 | A = 0 | B = 1 | x := x + 1 | x = 64 |

### REFERENCES

[1] Mike Hannah, “Implementation of the Double Precision Complex FFT for the TMS320C54x DSP,” Texas Instruments, Application Report, SPRA554B, August 1999.
[2] Guy R. L. Sohie, “Implementation of Fast Fourier Transform on Motorola's Digital Signal Processors,” Motorola's High Performance DSP Technology, APR4/D, Rev. 3, Sections 4, 6, 8.
[3] Steven W. Smith, The Scientist and Engineer's Guide to Digital Signal Processing, California Technical Publishing, 1997: 228-232.
[4] Tukey and Cooley, “An Algorithm for the Machine Calculation of Complex Fourier Series,” Mathematics of Computation Vol. 19, Apr. 15, 1965: 297-301.
[5] Tao Ran, Ping Xianjun, Shen Yu, and Zhao Xinghao, “A Novel Discrete Fractional Fourier Transform,” IEEE Press, October 2001: 1028-1029.
[6] W. H. Beyer, CRC Standard Mathematical Tables, 28^{th} ed., CRC Press, 1987.
[7] Richard J. Higgins, Digital Signal Processing in VLSL, Prentice-Hall, 1990: 127-138.
[8] Analog Devices, Digital Signal Processing Application: Using the ADSP-2100 Family, Prentice-Hall, 1990: 253-368.
[9] Matteo Firgo and Steven G. Johnson, “The Fastest Fourier Transform in the West,” MIT-LCS-TR-728, MIT, Sep. 11, 1997.
[10] Matteo Firgo and Steven G. Johnson, “FFTW,” FFTW homepage, www.fftw.org.
[11] George M. Dillard, “Method and Apparatus for Computing the Fourier Transform Recursively,” August 1974.
[12] Donald A. Perreault and Thomas C. Rich, “Method and Apparatus for Suppression of Error Accumulation of Discrete Fourier Transform,” September 1978.
[13] Walter E. Pelton, Trang K. Ta, Nipa Yossakda, and Pochang Hsu, “Sample Integrated Fourier Transform (SIFT) with High-Performance ASIC Implementation,” MAPLD 2001 Conference, Maryland, Sep. 10-13, 2001.
[14] Walter E. Pelton, Trang K. Ta, Nipa Yossakda, and Pochang Hsu, “Sample Integrated Fourier Transform (SIFT): A Novel Real-time Process,” IEEE ASIC/SoC, September 2001, Washington D.C.
[15] Walter E. Pelton, Adrian Stoica, and Nipa Yossakda, “Sliding Aperture Fourier Transform (SAFT): A Low-Latency Continuous Process,” 2001 CIE International Conference on Radar Proceedings, Oct. 15-18, 2001, Beijing, China.
[16] Johannes Steensma, “A Design Methodology for The Efficient Implementation of Complex DSP Algorithms in FPGAs,” Apr. 4, 2001.
[17] DSP Architectures, http://www.dsparchitectures.com/dsp 4, “DSP24 Ultra-High Performance Digital Signal Processor,” 2001.
[18] Walter E. Pelton, “Apparatus, Methods and Computer Program for Determining the Coefficients of a Function with Decreased Latency,” April 1999 Patent.
[19] R. N. Bracewell, Fourier Transform and its Application, Rev. 2, New York, 1986.
[20] Walter E. Pelton and Adrian Stoica, “Methods and Computer Program Products For Accurately Determining the Coefficients of a Function,” February 2000 Patent.
[21] Phillippe Elleaume, “Device for Computing a Sliding and Nonrecursive Discrete Fourier Transform and its Application to a Radar System,” Patent May 1990.
[22] Arthur Beiser, Physics, 5^{th} Edition. Addison-Wesley:1991, p. 160-162, 189-190.
[23] Jeff Bier, “So Many Architectures, So Little Time: Difficult Choices for Signal Processing,” Texas Instruments, January 2003.

1. A method of determining a coefficient of a function representative of a signal, comprising:
(a) adding a first complex value representative of a first sample of the signal to a coefficient register; and
(b) rotating the coefficient.

2. The method of claim 1, wherein the complex value is a real value.

3. The method of claim 1, further comprising:
(c) adding an n^{th} complex value representative of an n^{th} sample of the signal to the coefficient register;
(d) rotating the coefficient; and
(e) repeating (c) and (d) at least n times;
wherein n is at least 2, and
each sample of the signal is obtained at identically spaced time intervals.

4. The method of claim 3, wherein n is 8-1000.

5. A method of determining a plurality of coefficients of a function representative of a signal, comprising:
determining each of the coefficients by the method of claim 3;
wherein the plurality is n.

6. The method of claim 5, wherein the complex value is a real value.

7. The method of claim 1, wherein the function is a Discrete Fourier Transform of the signal.

8. The method of claim 3 wherein the function is a Discrete Fourier Transform of the signal.

9. The method of claim 5, wherein the function is a Discrete Fourier Transform of the signal.

10. The method of claim 1, wherein the coefficient is an RSIFT coefficient.

11. A method of determining a coefficient of a function representative of a first portion of a signal, comprising:
(a) adding a 2n^{th} complex value to a coefficient register; and
(b) rotating the coefficient;
wherein the register contains a coefficient of the function representative of a second portion of the signal,
n is at least 2,
the 2n^{th} complex value is the difference between an n^{th} sample of the signal and a 2n^{th} sample of the signal,
the second portion is of the same length as the first portion, and
each sample of the signal is obtained at identically spaced time intervals corresponding to the length of the first portion divided by n.

12. The method of claim 11, wherein the complex value is a real value.

13. The method of claim 11, wherein n is 8-1000.

14. The method of claim 11, wherein the function is a Discrete Fourier Transform of the signal.

15. The method of claim 11, wherein the function is a Sliding Aperture Discrete Fourier Transform of the signal.

16. The method of claim 11, wherein the coefficient is an RSAFT coefficient.

17. An apparatus for determining a coefficient of a function representative of a signal, comprising:
an interface adapted to receive the signal and to sample the signal to form a plurality of samples;
a memory adapted to store a plurality of coefficients; and
a processor coupled to the memory and to the interface, the processor adapted to add a next plurality of samples to the plurality of coefficients and to rotate each coefficient of the plurality of coefficients by a corresponding angular factor, and to provide the rotated plurality of coefficients as a plurality of coefficients.

18. The apparatus of claim 17, wherein the plurality is 8-1000, and each sample of the signal is obtained at identically spaced time intervals.

19-22. (canceled)

23. A tangible medium storing computer readable software for determining a coefficient of a function representative of a signal, the tangible medium storing computer readable software comprising:
(a) a first program for adding a first complex value representative of a first sample of the signal to a coefficient register, and
(b) a second program for rotating the coefficient.

24. (canceled)

25. A tangible medium storing computer readable software for determining a coefficient of a function representative of a first portion of a signal, comprising:
(a) a first program for adding an 2n^{th} complex value to a coefficient register; and
(b) a second program for rotating the coefficient;
wherein the register contains a coefficient of the function representative of a second portion of the signal,
n is at least 2,
the 2n^{th} complex value is the difference between an n^{th} sample of the signal and a 2n^{th} sample of the signal,
the second portion is of the same length as the first portion, and
each sample of the signal is obtained at identically spaced time intervals corresponding to the length of the first portion divided by n.
